(19) United States
(12) Patent Application Publication
(10) Pub. No.: US 2024/0174926 A1
(43) Pub. Date: May 30, 2024

(54) METAL OXIDE ZINC RICINOLEATE NANOCOMPOSITE PARTICLES AND SURFACTANT COMPOSITIONS

(71) Applicant: Nevitt Frangrances, Inc., Dallas, TX (US)

(72) Inventor: Thomas Jason Pisklak, Cypress, TX (US)

(21) Appl. No.: 18/506,463

(22) Filed: Nov. 10, 2023

Related U.S. Application Data
(60) Provisional application No. 63/383,291, filed on Nov. 11, 2022.

(51) Int. Cl. C09K 23/00

(52) U.S. Cl. CPC C09K 23/018

(57) ABSTRACT

Disclosed are malodor counteractant formulations, concentrates, malodor counteractant compositions, surfactant compositions, methods of preparing the compositions, and methods of using the compositions. The malodor counteractant formulations and compositions include nanocomposite particles comprising metal oxide nanoparticles combined with zinc ricinoleate.

### CROSS-REFERENCE TO RELATED APPLICATION

This is a non-provisional patent application claiming the benefit of and priority to U.S. Provisional Patent Application No. 63/383,291, filed Nov. 11, 2022, all of which is incorporated by reference in its entirety.

### FIELD OF THE DISCLOSURE

The present disclosure generally relates to malodor counteractants, and more particularly to zinc-based malodor counteractants.

### BACKGROUND

Malodors, or very unpleasant smells, are ubiquitous in modern life and consequently there has been much scientific effort to either remove or mask malodors. Products that address malodor issues can be referred to as malodor abatement products and malodor counteractants.

The great majority of malodor abatement products utilize fragrances to simply mask malodor; however, the fragrance soon dissipates, and the malodor typically remains. Generally, malodor abatement compounds are delivered in aqueous form.

Malodor counteractants can physically and chemically remove malodors from the target environment. Malodor counteractants are typically based on cyclodextrin compounds and derivatives thereof. Although these compounds do physically and chemically remove malodors from the environment, it is not permanent. Malodor sequestration in cyclodextrin is an equilibrium reaction in which the malodor compounds are constantly adsorbing and desorbing into/onto the cyclodextrin compounds. Since the malodor is not permanently anchored to the cyclodextrin, there is a possibility that the cyclodextrin would adsorb other, non-malodor, compounds preventing the re-adsorption of the malodor and allowing it to re-disperse into the environment.

### SUMMARY

Disclosed herein are malodor counteractant compositions, methods of preparing the compositions, and methods of using the compositions. The malodor counteractant compositions are nanocomposite particles comprising metal oxide nanoparticles combined with zinc ricinoleate (also referred to herein as ZnO/ZnRicO NP).

Also disclosed herein are surfactant compositions. The surfactant compositions provide a clear colorless liquid. One of the surfactant compositions surprisingly provides a clear colorless liquid having viscosity similar to water. The surfactant compositions can be used in a formulation with a malodor counteractant, such as the nanocomposite particles disclosed herein, in an amount of from about 5.65 wt % to about 22.5 wt % based on a total weight of the formulation.

Also disclosed is a malodor counteractant formulation that includes the malodor counteractant composition and one of the surfactant compositions. The formulation can contain from about 0.1 wt % to about 15 wt %; alternatively, from about 0.5 wt % to about 0.6 wt %; alternatively, from about 3 wt % to about 15 wt % nanocomposite particles based on a total weight of the formulation. The surfactant compositions can be used at relatively low concentrations in the formulations (e.g., from about 5 wt % to about 50 wt % surfactant composition based on a total weight of the formulation) to suspend these nanocomposite particles in such a manner so as to obtain a clear, almost colorless solution.

It has been found that the surfactant compositions disclosed are suitable for the deagglomeration and suspension of the nanocomposite particles to form clear and/or colorless formulations. In aspects, the surfactant composition can comprise i) a single surfactant or ii) a first surfactant and a second surfactant. In aspects having two surfactants, the surfactant composition can contain from about 1 wt % to about 99 wt % of the first surfactant and from about 1 wt % to about 99 wt % of the second surfactant based on a total weight of the surfactant composition.

For a concentrate formulation, the malodor counteractant composition can be present in an amount of from 6 wt % to about 14 wt % and the surfactant composition can be present in an amount of from 22.5 wt % to 60 wt % based on a total weight of the concentrate formulation.

The surfactant compositions disclosed herein can be used in other formulations where a clear colorless liquid is desired.

In some aspects, a formulation disclosed herein can contain a fragrance to make the product more desirable to consumers.

Also disclosed is a method for preparing metal oxide zinc ricinoleate nanocomposite particles, the method comprising a first stage and a second stage. In the first stage, the method includes forming metal oxide zinc ricinoleate nanocomposite seed particles in a base solution. In the second stage, the method includes growing the metal oxide zinc ricinoleate nanocomposite seed particles in the base solution to form the metal oxide zinc ricinoleate nanocomposite particles in the base solution.

Another method disclosed herein is a method for preparing a malodor counteractant formulation includes combining a base solution containing metal oxide zinc ricinoleate nanocomposite particles with a surfactant composition, wherein the surfactant composition comprises at least one surfactant disclosed herein.

Another method disclosed herein is a method for counteracting malodors, that includes applying a formulation disclosed herein to a target environment.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 is a perspective view of a metal oxide zinc ricinoleate nanocomposite particle.

FIG. 2 is an X-ray diffractogram of the exemplary formulation.

FIG. 3 is a photo of an experimental setup for testing viscosity of the disclosed surfactant compositions.

FIG. 4 is a graph of Malodor Counteractant Formulation versus Grams Malodor (g) 100% POJ.

FIG. 5 is a graph of Malodor Counteractant Formulation versus Grams Malodor (g) 100% LA.

FIG. 6 is a graph of Malodor Counteractant Formulation versus Grams Malodor (g) 100% Pure IVA.

### DETAILED DESCRIPTION

As used herein, any recited ranges of values contemplate all values within the range including the end points of the range, and are to be construed as support for claims reciting any sub-ranges having endpoints which are real number values within the recited range. By way of example, a disclosure in this specification of a range of from 10 to 15 shall be considered to support claims to values of 10, 11, 12, 13, 14, and 15, and to any of the following ranges: 10-11, 10-12, 10-13, 10-14, 10-15, 11-12, 11-13, 11-14, 11-15, 12-13; 12-14, 12-15, 13-14, 13-15, and 14-15.

Disclosed herein is a malodor counteractant composition comprised of metal oxide zinc ricinoleate nanocomposite particles (referred to as ZnO/ZnRicO NP). Also disclosed is a formulation containing the malodor counteractant composition and a surfactant composition.

The metal oxide is used in the malodor counteractant composition in the form of nanoparticles. The metal oxide nanoparticles (abbreviated generally as MtₙOₓ NP, Mt=metal, O=oxygen, NP=nanoparticles, n=integer, x =integer) can have at least one dimension (e.g., diameter, length, width, height, or combinations thereof) in a range of from about 1 nm to about 100 nm; alternatively, from about 1 nm to about 90 nm; alternatively, from about 1 nm to about 80 nm; alternatively, from about 1 nm to about 70 nm.

The metal in the metal oxide can be any metal for which the metal oxide has both antimicrobial (source of odor) and malodor counteractant properties. In aspects, the metal in the metal oxide can be selected from zinc, copper, iron, titanium, or combinations thereof. In aspects, the metal oxide can be selected from ZnO, CuO, Fe₂O₃, TiO₂, or combinations thereof.

Zinc ricinoleate (ZnRicO) is also known as zinc bis[(9Z, 12R)-12-hydroxy-9-octadecenoate]. Zinc ricinoleate has the follow chemical structure:

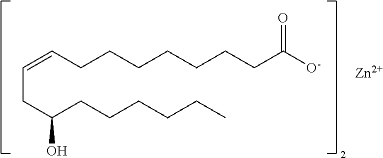

The nanocomposite particles formed by combining the MtₙOₓ NP and ZnRicO can have at least one dimension (e.g., diameter, length, width, height, or combinations thereof) in a range of from about 1 nm to about 1 mm.

The formulations containing the nanocomposite particles can be formulated using relatively low concentrations of the surfactant composition, such as the formulation containing from about 11.5 wt % to about 22.5 wt % surfactant composition based on a total weight of the formulation.

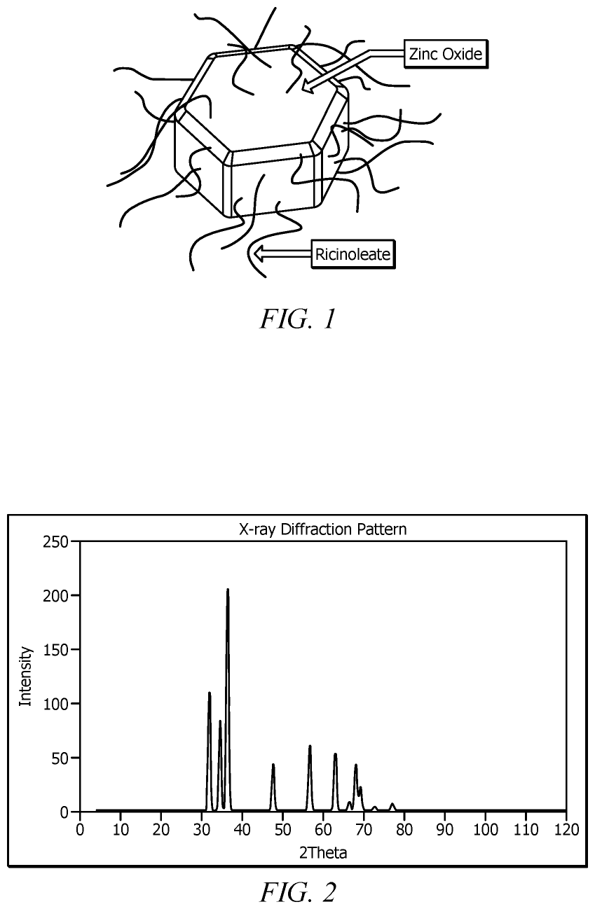

In contrast to other malodor removal compounds currently marketed, the disclosed formulations containing MtₙOₓ/ZnRicO nanocomposite particles remove malodor molecules from the environment through three separate removal mechanisms: chemical, physical, and solvation. The chemical removal mechanism occurs through malodor molecule interaction with one or more of the zinc ricinoleate molecules extending from the surface of the MtₙOₓ nanoparticle and with the surface of the MtₙOₓ nanoparticle (see FIG. 1). The physical removal mechanism occurs because the malodor molecules are physically removed from the environment after the chemical interaction occurs. This is because the chemical interaction in non-reversible and the malodor molecule remains associated with the nanocomposite particle and is no longer free to contaminate the environment. The solvation removal mechanism is driven by the presence of surfactants in the formulation. The surfactants help solvate oily malodors and bring them into the aqueous phase and eventually into contact with the nanocomposite malodor counteractant.

Without being limited by theory, it is believed that MtₙOₓ/ZnRicO nanocomposite particles complex and/or react strongly and irreversibly with malodor molecules. The complexation and/or reaction effectively “locks” a malodor molecule to the MtₙOₓ/ZnRicO nanocomposite particle, preventing the malodor molecule from reentering the environment.

The procedure below was utilized to produce malodor counteractant formulations containing the MtₙOₓ/ZnRicO nanocomposite particles.

### Base Solution

A base solution is produced by combining water, zinc ricinoleate, a structure directing agent (SDA), a solubility aid, and a metal donor. The base solution can be prepared in two stages: a first stage that forms nanocomposite seed particles, and a second stage that grows the nanocomposite seed particles to a dimension disclosed herein to form the nanocomposite particles. The base solution can have about 15 wt % to about 25 wt %; alternatively, about 20 wt % nanocomposite particles based on a total weight of the base solution.

The structure directing agent (SDA) can be a basic compound or solution. Suitable SDAs include aqueous arginine, sodium hydroxide, potassium hydroxide, lithium hydroxide, potassium carbonate, ammonia and sodium bicarbonate, ammonium salts, primary, secondary and tertiary amines, such as, e.g., lower alkylamines such as methylamine, t-butylamine, procaine, ethanolamine, arylalkylamines such as dibenzylamine and N,N-dibenzylethylenediamine, lower alkylpiperidines such as N-ethylpiperidine, cycloalkylamines such as cyclohexylamine or dicyclohexylamine, morpholine, glucamine, N-methyl- and N,N-dimethylglucamine, 1-adamantylamine, benzathine, or salts derived from amino acids like lysine, ornithine or amides of originally neutral or acidic amino acids or the like. In aspects, the SDA has a high pKa. In aspects, other structure directing agents known in the art with aid of this disclosure can be used.

An example of a solubility aid is propylene glycol. Other solubility aids known in the art with aid of this disclosure can be used, such as other glycol-based compounds, e.g., dipropylene glycol.

The metal donor can be zinc, copper, iron, titanium, or combinations thereof.

The table below shows the composition of an exemplary base solution:

Base Solution

| Material | Weight (g) |
|---|---|
| Water | 50.0 |
| ZnRicO | 40.0 |
| Arginine | 50.0 |
| Propylene Glycol | 60.0 |
| ZnCl₂ | 2.2 |

Water and ZnRicO can be seen as present in the base solution. Arginine is the structure directing agent, ZnCl₂ is the zinc donor, and propylene glycol is the solubility aid. Oxygen atoms in the solution and the zinc atoms from ZnCl₂ combine to form ZnO nanoparticles, and the ZnRicO combines with the ZnO nanoparticles to form nanocomposite seed particles.

The exemplary base solution was formed according to the following steps:
a. Add 40.0 g water to flat bottom flask and heat to 100° C. with reflux.
b. Add 5.0 g Arginine to flask, stir for 5 minutes to dissolve.
c. Add 1.0 g ZnRicO to the same flask, stir for 15 minutes to melt.
d. In a separate container:
   i. Add 10.0g water
   ii. Heat the water to ˜100° C.
   iii. Add 2.2 g ZnCl₂ and dissolve with stirring.
   iv. Use an addition funnel to add the contents of the separate container dropwise to the flat bottom flask over 10.0 minutes. The ZnCl₂ is added slowly to foster nanoparticle formation.
e. Add 60.0 g PG to the flask.
f. Add 45.0 g Arginine to the flask, and continue stirring.
g. Add 39.0 g ZnRicO pellets to the flask
   i. Continue heating and stirring until all pellets are dissolved, about 15 minutes.
h. Cool the base solution to room temperature and store in a sealed container.

In the above method, the first stage that forms nanocomposite seed particles contains steps a to d, and the second stage the grows the nanocomposite particles to desired dimension contains steps e to g.

### Formulation

The formulation can be formed by combining the base solution with a surfactant composition. The surfactant composition can contain one or more surfactants. In some aspects, the surfactant composition consists of one surfactant. In some aspects, the surfactant composition consists of two surfactants. In some aspects, the surfactant can be selected from any surfactant disclosed herein.

In some aspects, any surfactant in the surfactant composition can be independently selected from an anionic surfactant, a cationic surfactant, a nonionic surfactant, or a zwitterionic surfactant.

Anionic surfactants can include a stearate, a sulfate, a disulfate, a polysulfate, a sulfonate, a disulfonate, a polysulfonate, a sulfosuccinate, a disulfosuccinate, a polysulfosuccinate, a carboxylate, a dicarboxylate, a polycarboxylate, or any combination thereof. In some examples, the anionic surfactant can comprise an alkyl sulfate, an alcohol sulfate, an alkoxy sulfate, an alkyl sulfonate, an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di)sulfonate, an alkoxy sulfonate, an alkoxy carboxylate, an alcohol phosphate, or an alkoxy phosphate. Commercially available examples of anionic surfactant include sodium lauryl sulfate (SLS), sodium lauryl ether sulfate (SLES), sodium stearate, CALSOFT® surfactant products, and PENTEX® 99 surfactant product.

Cationic surfactants can include primary amines, secondary amines, tertiary amines, quaternary ammonium compounds (also referred to as quats), benzalkonium chloride, and cetyl trimethylammonium chloride.

“Zwitterionic” as used herein refers to a neutral molecule with a positive (or cationic) and a negative (or anionic) electrical charge at different locations within the same molecule. Zwitterionic surfactants may also be referred to herein as amphoteric surfactants. Zwitterionic surfactants can include betains and sultains. Examples of zwitterionic surfactants used herein include cocamidopropyl betaine (CAB) and lauryl dimethylamine oxide (LDAO).

Nonionic surfactants can include alkoxy alcohols, alkyl aryl alkoxy alcohols, alkyl alkoxy alcohols, or any combination thereof. In aspects, the nonionic surfactant can be a nonionic alkoxylated linear alcohol, a polysorbate, or a sorbitan ester (also known as a span). Examples of nonionic surfactants utilized herein include Polysorbate 80, SURFONIC® JL-80X, TERGITOL™ surfactants, and Poloxamer 407.

The table below shows the composition of an exemplary formulation:

| Material | Weight (%) |
|---|---|
| ZnO/ZnRicO NP | 3.1 |
| 70% Surfactant | 15.7 |
| 30% Surfactant | 6.7 |
| Propylene Glycol | 8.5 |
| Water | 62.2 |
| L-Arginine | 3.8 |
| Citric Acid | 0.001 |

It can be seen that the exemplary formulation contains the components of the base solution and a surfactant composition having a first surfactant and a second surfactant. The first surfactant was cocamidopropyl betaine (CAB), and the second surfactant was a surfactant known as SURFONIC® JL-80X available from Huntsman Chemical (JL-80X). The formulation also contains citric acid in the amount shown.

The exemplary formulation was formed according to the following steps:
a. At room temperature, add the Base Solution to container.
b. With stirring, add in surfactants, followed by water, and then propylene glycol.
c. Finally, adjust pH to 7.0 to 8.0 using a 50 wt % citric acid (CA) solution, if desired.

To confirm the presence of nanoparticles after synthesis, the following procedure was performed: About 100 ml of the formulation was added to a plastic container. The container was left open and placed in an oven which was set at 180° F. After four days the sample had completely dried, and a fine white powder remained. This powder was collected and submitted for x-ray diffraction (XRD) analysis to determine the crystalline phases present as well as the crystallite size. The XRD analysis was performed using a PANalytical X'Pert Pro diffractometer.

The X-ray diffractogram is illustrated in FIG. 2. As can be seen in FIG. 2, the X-ray diffractogram confirms the presence of zinc oxide particles. That is, the XRD pattern (diffractogram) was compared to the patterns of known materials, and it was determined that zinc oxide (zincite) was the main crystalline phase present. The comparative standard pattern is available on mindat.org (www.mindat.org/min-4410.html#autoanchor10). Furthermore, the Scherrer equation was applied to the obtained data to determine the size of the zinc oxide crystals. The calculated crystal size was 31.6±7 nanometers.

EXAMPLES

Formulation experiments were performed to investigate the effect of various surfactants and surfactant combinations on shelf-life of the formulations. Failure to maintain an effective shelf-life is typically evidenced by solution instability, such as formation of white precipitate or phase separation of components.

Shelf life at 33° F. in a refrigerator was evaluated with an overall goal of full stability at 30 days. To standardize the results, a rating system was developed to describe the formulations each time they were observed, as seen in the table below:

| Property | Designation |
|---|---|
| Clear = | A |
| Slightly Cloudy = | B |
| Very Cloudy = | C |
| Low Viscosity = | D |
| Mid Viscosity = | E |
| Gelled = | F |
| Stable = | G |
| Separated = | H |
| Turbidity = | I |
| No Turbidity = | J |

Formulations were removed from the refrigerator once they gained a rating of very cloudy (C) or at 30 days.

Each formulation contained 22.5 wt % surfactant composition based on a total weight of the formulation. Each formulation was prepared by blending the components according to the above procedures. About 40 ml of each formulation was placed in a 50 ml Falcon tube for shelf-life testing.

The table below describes the two different types of formulations that were utilized in the examples.

100 MC Solution

| Material | Weight (%) |
|---|---|
| Base Solution | 15.1 |
| Surfactant | 22.5 |
| Propylene Glycol | 4.0 |
| Water | 58.4 |

70/30 MC Solution

| Material | Weight (%) |
|---|---|
| Base Solution | 15.1 |
| 70 Surfactant | 15.7 |
| 30 Surfactant | 6.8 |
| Propylene Glycol | 4.0 |
| Water | 58.4 |

The first type of formulation was referred to as the “100 MC Solution”, which included formulations having a single surfactant in the surfactant composition of the formulation, i.e., 100 wt % of a single surfactant based on a total weight of the surfactant composition. The second type of formulation was referred to as the “70/30 MC Solution”, which included formulations having a surfactant blend with 70 wt % of a first surfactant and 30 wt % of a second surfactant based on a total weight of the surfactant composition. The formulations were normalized so that surfactants obtained at various activities (i.e. 28 wt % solution versus a 100 wt % solution) could be mixed at the same concentration.

Surfactants were generally available as pure surfactant or surfactant in an aqueous surfactant solution. For surfactants available for testing in an aqueous surfactant solution, adding the surfactant meant that water from the aqueous surfactant solution was also added. For addition of surfactant in an aqueous surfactant solution, the total amount of water added to each formulation was adjusted to keep all other component concentrations the same as the other formulations. For example, with a 30 wt % activity aqueous surfactant solution, to reach 3.375 grams of pure surfactant in the formulation, 11.25 grams of the aqueous surfactant solution was added (3.375 g pure surfactant+7.875 g water); the amount of water added to the formulation separately of the aqueous surfactant solution was 21.375 grams. In comparison, for a pure surfactant added to reach 3.375 grams of pure surfactant in the formulation, 29.25 grams of water was added to the formulation.

The formulations were stored in the refrigerator at a temperature of 33° F. and observed once daily. Observations were designated according to the following codes:

| Property | Designation |
|---|---|
| Clear = | A |
| Slightly Cloudy = | B |
| Very Cloudy = | C |
| Low Viscosity = | D |
| Mid Viscosity = | E |
| Gelled = | F |
| Stable = | G |
| Separated = | H |
| Turbidity = | I |
| No Turbidity = | J |

The table below contains the results of the shelf-life study of 67 different surfactant formulations. The first table below contains results for single surfactants, and in the “Surfactant” column, the surfactant abbreviations are listed. The second table below contains results for combinations of surfactants, and in the “Surfactant (70/30)” column, the surfactant abbreviations are listed. In the second table below, the first surfactant abbreviation was the 70 wt % component of the surfactant composition and the second surfactant abbreviation was the 30 wt % component.

| | Final | # Days Before |
|---|---|---|
| Surfactant | Description | Fail |
| Terg | AEGJ | >30 |
| SLS | CFHJ | 1 |
| SLES | ADGJ | >30 |
| LDAO | AEGJ | >30 |
| CAB | BDHJ | 1 |
| JL-80X | ADGJ | >30 |
| P80 | BDHI | 6 |
| Gain | BEGJ | 1 |
| P407 | ADGJ | 2 |

| Surfactant | Final | # Days Before |
|---|---|---|
| (70/30) | Description | Fail |
| Terg/SLS | AEGJ | >30 |
| Terg/SLES | AE2GJ | >30 |
| Terg/LDAO | AEGJ | >30 |
| Terg/CAB | AEGJ | >30 |
| Terg/JL-80X | ADGJ | >30 |
| Terg/P80 | AE2GJ | >30 |
| Terg/Gain | AEGJ | >30 |
| SLS/Terg | BEHJ | 5 |
| SLS/SLES | AFGJ | 1 |
| SLS/LDAO | BFGJ | 1 |
| SLS/CAB | AFGJ | 1 |
| SLS/JL-80X | BEHJ | 11 |
| SLS/P80 | AFGJ | 1 |
| SLS/Gain | BEHJ | 3 |
| SLES/Terg | AEGJ | >30 |
| SLES/SLS | AFGJ | 1 |
| SLES/LDAO | BFGJ | 1 |
| SLES/CAB | ADGJ | >30 |
| SLES/JL-80X | ADGJ | >30 |
| SLES/P80 | AEGJ | >30 |
| SLES/Gain | ADHJ | 6 |
| LDAO/Terg | AFGJ | >30 |
| LDAO/SLES | AEGJ | >30 |
| LDAO/SLS | CFHS | 1 |
| LDAO/CAB | ADGJ | >30 |
| LDAO/JL-80X | ADGJ | >30 |
| LDAO/P80 | AEGJ | >30 |
| LDAO/Gain | AEGJ | >30 |
| CAB/Terg | AEGJ | >30 |
| CAB/SLS | CDGJ | 1 |
| CAB/SLES | AEGJ | >30 |
| CAB/LDAO | AEHJ | 4 |
| CAB/JL-80X | ADGJ | >30 |
| CAB/P80 | ADGJ | >30 |
| CAB/Gain | CDGJ | 1 |
| JL-80X/Terg | ADGJ | >30 |
| JL-80X/SLS | ADGJ | >30 |
| JL-80X/SLES | ADGJ | >30 |
| JL-80X/LDAO | ADGJ | >30 |
| JL-80X/CAB | ADGJ | >30 |
| JL-80X/P80 | ADGJ | >30 |
| JL-80X/Gain | ADGJ | >30 |
| P80/Terg | ADGJ | >30 |
| P80/SLS | AEGJ | >30 |
| P80/SLES | ADGJ | >30 |
| P80/CAB | ADGJ | >30 |
| P80/JL-80X | ADGJ | >30 |
| P80/Gain | BDGJ | 6 |
| P407/SLS | ADGJ | 2 |
| P407/SLES | ADGJ | 2 |
| P407/CAB | ADGJ | 2 |
| P407/JL-80X | ADGJ | 2 |
| P407/P80 | ADGJ | 2 |
| SLS/P407 | ADGJ | 1 |
| SLES/P407 | ADGJ | 3 |
| CAB/P407 | ADGJ | 14 |
| JL-80X/P407 | ADGJ | 1 |
| P80/P407 | ADHI | 1 |

The surfactant abbreviations are shown in the table below:

| Abbreviation | Trade Name | Chemical Name | Manufacturer/Vendor |
|---|---|---|---|
| Terg | Tergitol | α-(4-nonylphenyl)-ω- | Univar |
| | | hydroxypoly(oxyethylene) | |
| SLS | Calimulse SLS | Sodium Lauryl Sulfate | Pilot Chemical |
| | | | Company |
| SLES | CalFoam ES-303 | Sodium Lauryl Ether Sulfate | Pilot Chemical |
| | | | Company |
| LDAO | Ammonyx LO | Lauryldimethylamine oxide | Stepan |
| CAB | — | Cocamidopropyl Betaine | Pure |
| JL-80X | Surfonic ® JL-80X | — | Huntsman Chemical |
| P80 | Polysorbate 80 | Polyoxyethylene sorbitan | Velona Natural Oils |
| | | oleate | |
| Gain | Gain Ultra | — | Procter and Gamble |
| P407 | Poloxamer 407 | EO/PO Copolymer | Spectrum Chemicals |

As can be seen above, thirty-seven of the surfactant compositions, when used in formulations with the zinc oxide zinc ricinoleate nanocomposite particles disclosed herein, showed acceptable stability at 30 days shelf-life.

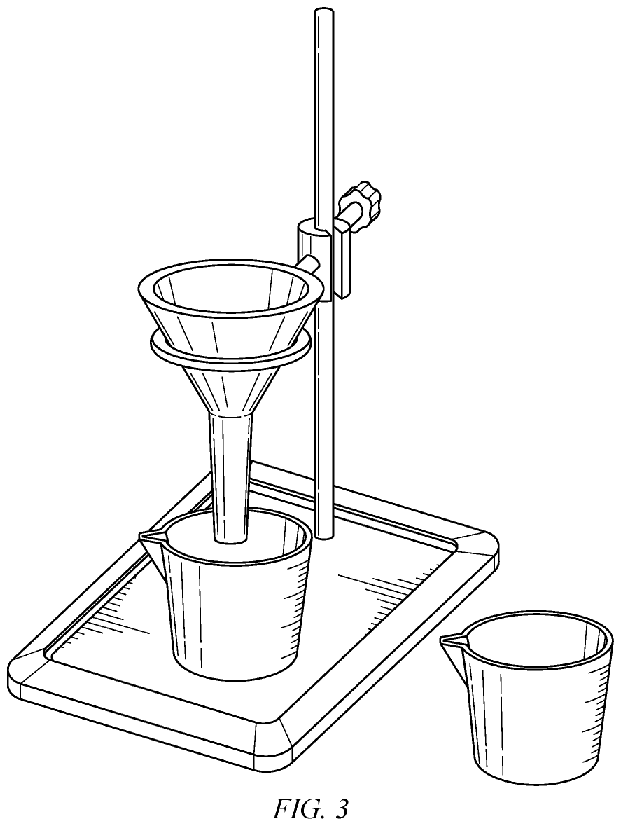

The thirty-six surfactant compositions were then measured for viscosity. The viscosity measurement procedure described below was performed on each of the thirty-six formulations that had acceptable stability at 30 days, performed at 33° F. and at 68° F. A method was developed using a modified Marsh Funnel technique. A photo of the equipment set-up is shown in FIG. 3.

The viscosity measurement method included: 1) 40.0 grams of surfactant composition was added to a beaker; 2) the surfactant composition was then poured as quick as possibly into the funnel; 3) upon start of pouring, a timer was also started; and 4) when the surfactant composition stopped flowing through the funnel, the timer was stopped. The time required for the liquid to flow through the funnel is correlated to the viscosity.

To calibrate the measurement procedure, several standard fluids were tested at 68° F. Water had a measurement time of 5.2 seconds, milk 6.5 seconds, light cream 8.2 seconds, and maple syrup 56.5 seconds.

The table below shows the viscosity measurement results of the thirty-six surfactant compositions that had stability at 30 days shelf life. In the “Surfactant (70/30)” column, the surfactant abbreviations utilized for each formulation are listed. If the row contains one surfactant abbreviation, then that surfactant was the only surfactant used in the surfactant composition. If the row contains two surfactant abbreviations, the first surfactant abbreviation was the 70 wt % component of the surfactant composition and the second surfactant abbreviation was the 30 wt % component.

| | # Days | | |
|---|---|---|---|
| Surfactant | Before | Viscosity at 33° F. | Viscosity at 68° F. |
| (70/30) | Fail | (sec) | (sec) |
| CAB/JL-80X | >30 | 6.0 | 5.6 |
| JL-80X/CAB | >30 | 6.8 | 6.4 |
| CAB/P80 | >30 | 7.6 | 6.4 |
| JL-80X/Gain | >30 | 7.8 | 7.7 |
| P80/CAB | >30 | 9.3 | 7.9 |
| JL-80X | >30 | 10.9 | 8.6 |
| JL-80X/SLES | >30 | 11.3 | 9.2 |
| JL-80X/Terg | >30 | 11.7 | 8.0 |
| JL-80X/LDAO | >30 | 14.0 | 10.0 |
| JL-80X/P80 | >30 | 15.0 | 11.3 |
| CAB/Terg | >30 | 20.0 | 10.9 |
| LDAO/JL-80X | >30 | 22.0 | 11.8 |
| LDAO/CAB | >30 | 27.0 | 14.0 |
| P80/JL-80X | >30 | 27.0 | 19.5 |
| SLES/JL-80X | >30 | 29.0 | 16.0 |
| SLES/CAB | >30 | 31.0 | 12.0 |
| SLES | >30 | 34.0 | 11.1 |
| LDAO/Terg | >30 | 35.0 | 15.0 |
| P80/SLES | >30 | 35.0 | 17.0 |
| JL-80X/SLS | >30 | 36.0 | 14.9 |
| Terg/JL-80X | >30 | 46.0 | 19.0 |
| P80/Terg | >30 | 46.0 | 37.0 |
| LDAO/Gain | >30 | 47.0 | 20.0 |
| Terg/LDAO | >30 | 59.0 | 20.0 |
| LDAO | >30 | 79.0 | 25.0 |
| Terg/CAB | >30 | 81.0 | 23.0 |
| Terg/Gain | >30 | 87.0 | 21.0 |
| Terg | >30 | 101.0 | 29.0 |
| SLES/P80 | >30 | 102.0 | 16.0 |
| Terg/SLS | >30 | 127.0 | 41.0 |
| LDAO/P80 | >30 | 148.0 | 38.0 |
| Terg/P80 | >30 | 151.0 | 42.0 |
| Terg/SLES | >30 | 152.0 | 46.0 |
| P80/SLS | >30 | 184.0 | 23.0 |
| SLES/Terg | >30 | 202.0 | 39.0 |
| CAB/SLES | >30 | 211.0 | 62.0 |

Of note in the table above, the combination of CAB/JL-80X surprisingly resulted in the surfactant combination having the lowest viscosity of the surfactants tested. CAB is a betaine surfactant, and betaine surfactants are used in the consumer products industry to increase viscosity (used as a viscosifier). That fact that a betaine surfactant was part of a surfactant composition that had the lowest viscosity of all surfactants tested, and that the viscosity was similar to water, was unexpected.

Since the goals were to develop a solution which was clear, colorless and stable at low temperatures as well as high, the ten formulations which had a 33° F. viscosity equal to or less than 15.0 seconds (CAB/JL-80X to JL-80X/P80) were subjected to increased temperature testing as well. The steps followed for this testing were:
I. Store samples at 33° F. for 30 days (already competed at this point)
II. Allow sample to natural warm to room temperature and store on benchtop for 24 hours.
III. Heat large pot of water, big enough to hold 10 samples, to 150° F.
   a. Add all samples to the heated water
   b. Keep samples in the heated water for 8 hours
IV. Remove samples from heated water and place in freezer (below 32° F.) for 12 hours and allow them to freeze to solid form.
V. Repeat III and IV two more times
VI. After three heating/cooling cycles, allow samples to rest at room temperature for at least 24 hours.

After being subjected to the above heating/cooling test, all 10 samples showed no change and were still clear, colorless and stable.

To determine if the surfactant loadings could be minimized, two more formulations were synthesized which yielded malodor counteractant formulations with total surfactant loadings of 11.25 wt % and 5.65 wt %, referred to as MC Solution 11.25 and MC Solution 5.65. Formulations for the 22.5 wt %, 11.25 wt %, and 5.65 wt % are the tables below.

MC Solution 22.5

| Material | Weight (g) |
|---|---|
| Base Solution | 15.1 |
| 70% Surfactant | 15.7 |
| 30% Surfactant | 6.7 |
| Propylene Glycol | 4.0 |
| Water | 58.4 |

MC Solution 11.25

| Material | Weight (g) |
|---|---|
| Base Solution | 14.9 |
| 70% Surfactant | 7.9 |
| 30% Surfactant | 3.4 |
| Propylene Glycol | 4.7 |
| Water | 69.1 |

MC Solution 5.65

| Material | Weight (g) |
|---|---|
| Base Solution | 15.1 |
| 70% Surfactant | 3.9 |
| 30% Surfactant | 1.8 |
| Propylene Glycol | 5.0 |
| Water | 74.2 |

The formulations in the tables above resulted in clear and nearly colorless malodor counteractant formulations. The composition of the formulations is shown in the tables below (wt %'s are +/−10%):

MC Solution 22.5

| Material | Weight (%) |
|---|---|
| ZnO/ZnRicO NP | 31 |
| 70% Surfactant | 15.7 |
| 30% Surfactant | 6.7 |
| Propylene Glycol | 8.5 |
| Water | 62.2 |
| L-Arginine | 3.8 |
| Citric Acid | 0.001 |

MC Solution 11.25

| Material | Weight (%) |
|---|---|
| ZnO/ZnRicO NP | 3.1 |
| 70% Surfactant | 7.9 |
| 30% Surfactant | 3.4 |
| Propylene Glycol | 9.1 |
| Water | 72.8 |
| L-Arginine | 3.7 |
| Citric Acid | 0.001 |

MC Solution 5.65

| Material | Weight (%) |
|---|---|
| ZnO/ZnRicO NP | 3.1 |
| 70% Surfactant | 3.9 |
| 30% Surfactant | 1.8 |
| Propylene Glycol | 9.5 |
| Water | 78.0 |
| L-Arginine | 3.8 |
| Citric Acid | 0.001 |

The MC Solution 22.5, MC Solution 11.25, and MC Solution 5.65 were then subjected to cooling at 33° F. for 30 days and subsequently, for those that survived, the heating/cooling process described previously. The results were collected and are presented in the table below:

| Surfactant | Total Surfactant | | # Days Before |
|---|---|---|---|
| (70/30) | Concentration (wt %) | Description | Fail |
| CAB/JL-80X | 22.5 | ADGJ | >30 |
| CAB/JL-80X | 11.25 | ADGJ | >30 |
| CAB/JL-80X | 5.65 | ADHJ | 2 |
| CAB/P80 | 22.5 | ADGJ | >30 |
| CAB/P80 | 11.25 | ADHJ | 2 |
| CAB/P80 | 5.65 | ADHJ | 2 |

Three of the solutions survived the shelf-life testing, these were CAB/JL-80X (22.5%), CAB/JL-80X (11.25%) and CAB/P80 (22.5%). All three of these remained clear, colorless and stable throughout the testing process. Based on this testing, a minimum surfactant load with the ZnO/ZnRicO nanocomposite particles can be in a range of from about 5.65 wt % and to about 11.25 wt %.

Two more malodor counteractant formulations were tested to determine if higher loadings of ZnO/ZnRicO NPs could be stable under such extreme shelf-life testing conditions. The composition of the Base Solution used in each formulation, as well as the composition of the remainder of the formulations are shown in the tables below (wt %'s are +/−10%).

Base Solution

| Material | Weight (g) |
|---|---|
| Water | 50.0 |
| ZnRicO | 40.0 |
| Arginine | 50.0 |
| Propylene Glycol | 60.0 |
| ZnCl | 2.2 |

MC Solution 6

| Material | Weight (g) |
|---|---|
| Base Solution | 35.0 |
| 70% Surfactant | 19.7 |
| 30% Surfactant | 8.4 |
| Propylene Glycol | 0.0 |
| Water | 53.0 |

MC Solution 9

| Material | Weight (%) |
|---|---|
| Base Solution | 45.5 |
| 70% Surfactant | 26.0 |
| 30% Surfactant | 11.1 |
| Propylene Glycol | 0.0 |
| Water | 17.6 |

MC Solution 6

| Material | Weight (%) |
|---|---|
| ZnO/ZnRicO NP | 6.2 |
| 70% Surfactant | 17.0 |
| 30% Surfactant | 7.2 |
| Propylene Glycol | 9.0 |
| Water | 53.1 |
| L-Arginine | 7.5 |
| Citric Acid | 0.002 |

MC Solution 9

| Material | Weight (%) |
|---|---|
| ZnO/ZnRicO NP | 9.3 |
| 70% Surfactant | 25.9 |
| 30% Surfactant | 11.1 |
| Propylene Glycol | 13.5 |
| Water | 28.8 |
| L-Arginine | 11.3 |
| Citric Acid | 0.003 |

“MC Solution 6” is a formulation with 6.2 wt % of the ZnO/ZnRicO nanocomposite particles, and “MC Solution 9” is a formulation with 9.3 wt % of the ZnO/ZnRicO nanocomposite particles. The first surfactant (the 70 wt % component of the surfactant composition) for MC Solution 6 and MC Solution 9 was CAB. The second surfactant (the 30 wt % component of the surfactant composition) for MC Solution 6 and MC Solution 9 was JL-80X. A Surfactant/ZnRicO ratio similar to MC Solution 11.25, ˜4:1 was maintained. MC Solution 6 contained 6.2 wt % ZnO/ZnRicO NPs while MC Solution 9 contained 9.3 wt %.

After synthesis, these two solutions were subjected to cooling at 33° F. for 30 days and subsequently, the heating/cooling process described previously. Both survived and were clear, mostly colorless and stable after testing.

### VALIDATION EXAMPLES

For validation of performance in regard to malodor removal, ZnO/ZnRicO NP nanocomposite malodor counteractant formulations were compared with 1) FEBREZE® FABRIC™ and 2) a commercially available zinc ricinoleate formulation, TEGODEO® A30 ECO. Results indicate that the ZnO/ZnRicO NP formulations outperformed FEBREZE® FABRIC™ and TEGODEO® A30 ECO. The following Malodor Abatement Test Procedure was performed for the comparison:
I. Weigh 10.0 grams of each malodor counteractant to be tested into 50 ml Falcon tubes.
   a. Place each tube into a holder and securely tighten lid.
II. Calibrate the pipette(s) which will be used add drops of malodor to the Falcon tubes.
   a. Place a beaker on a scale and tare.
   b. Use pipette to add 20 drops of water to the beaker
   c. Record the weight and divide by number of drops to obtain weight per drop.
III. Pipette a drop of the malodor into the open Falcon tubes containing malodor counteractant.
   a. Immediately replace the lid
   b. Record the number of drops in each tube
IV. Shake each Falcon tube and let sit static for at least one minute.
V. Remove the lid from each tube and allow to sit for one minute.
VI. Evaluate each tube for malodor smell.
   a. If malodor is detected, stop the test, continue to step VIII.
   b. If no malodor is detected continue to VII.
VII. Repeat steps III, IV, V, and VI.
   a. Continue repeating these steps until malodor is detected
   b. When malodor is detected, continue to step VIII.
VIII. Consolidate data and calculate results.

The malodor abatement test procedure described above was used to test the effectiveness of five different malodor counteractants:
1) a neutral ZnO/ZnRicO nanocomposite particle formulation having the following composition (wt %'s are +/−10%)

| Material | Weight (%) |
|---|---|
| ZnO/ZnRicO NP | 3.1 |
| 70% Surfactant | 15.7 |
| 30% Surfactant | 6.7 |
| Propylene Glycol | 8.5 |
| Water | 62.2 |
| L-Arginine | 3.8 |
| Citric Acid | 0.001 |

The first surfactant (the 70 wt % component of the surfactant composition) was CAB, and the second surfactant (the 30 wt % component of the surfactant composition) was JL-80X.
2) a ZnO/ZnRicO nanocomposite particle formulation with added NaOH (wt %'s are +/−10%),

NaOH 0.015 wt %

| Material | Weight (%) |
|---|---|
| ZnO/ZnRicO NP | 3.1 |
| 70% Surfactant | 15.7 |
| 30% Surfactant | 6.7 |
| Propylene Glycol | 8.5 |
| Water | 62.2 |
| L-Arginine | 3.8 |
| Citric Acid | 0.001 |

### NaOH 0.015 wt %

The first surfactant (the 70 wt % component of the surfactant composition) was CAB, and the second surfactant (the 30 wt % component of the surfactant composition) was JL-80X.
3) a ZnO/ZnRicO nanocomposite particle formulation with added NH4OH (wt %'s are +/−10%),

NH4OH 0.071 wt %

| Material | Weight (%) |
|---|---|
| ZnO/ZnRicO NP | 3.1 |
| 70% Surfactant | 15.7 |
| 30% Surfactant | 6.7 |
| Propylene Glycol | 8.5 |
| Water | 62.2 |
| L-Arginine | 3.8 |
| Citric Acid | 0.001 |

### NH4OH 0.071 wt %

The first surfactant (the 70 wt % component of the surfactant composition) was CAB, and the second surfactant (the 30 wt % component of the surfactant composition) was JL-80X.
4) the formulation known as FEBREZE® FABRIC™, and
5) a formulation of TEGODEO® A30 ECO having the following composition:

| Material | Weight (g) | Weight (%) |
|---|---|---|
| Tegodeo A30 Eco | 8.6 | 3.0 |
| Calimulse SLS 30% | 50.0 | 15.0 |
| Water | 41.4 | 82.0 |

Following the malodor test procedure described above, these five malodor counteractants were placed in Falcon tubes, and one tube contained only water as a control.

The first test utilized onion juice as the malodor, which was obtained by juicing fresh onions. The pure onion juice was then diluted with water to obtain a malodor solution that was 3.5 wt % pure onion juice and 96.5 wt % water (referred to as 3.5% POJ). After the data was collected, the weight in grams of the amount of 3.5% POJ was multiplied by 0.35 to obtain the weight of 100% POJ which was actually deodorized. The table below lists the results of the testing with 3.5% POJ:

| Malodor | Wt of MC | Odor Detected | Weight (g) |
|---|---|---|---|
| Counteractant | Solution (g) | (g 3.5% POJ) | 100% POJ |
| Neutral | 10.03 | 8.4 | 0.29 |
| NaOH | 10.00 | 9.2 | 0.32 |
| NH4OH | 10.02 | 10.0 | 0.35 |
| Febreze | 10.05 | 6.8 | 0.24 |
| Tegodeo | 10.02 | 10.0 | 0.35 |
| Water | 10.06 | 0.64 | 0.02 |

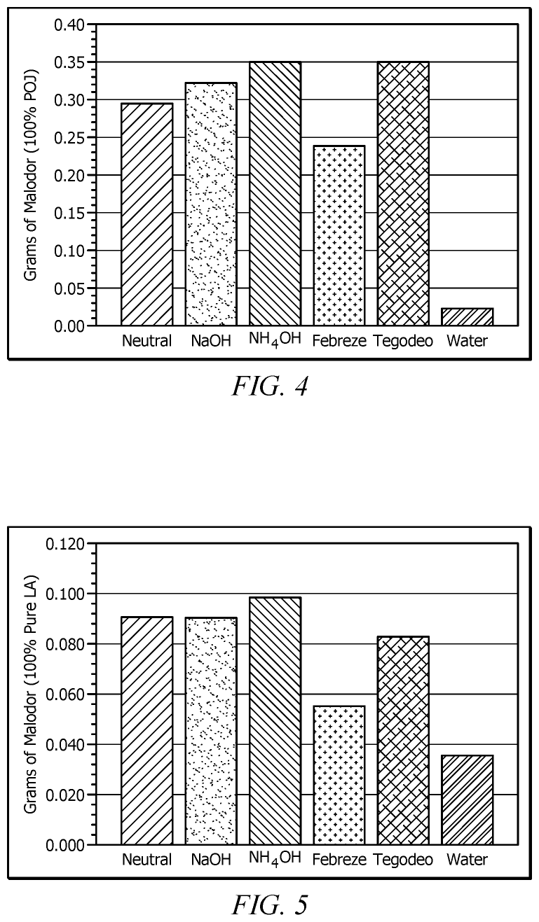

FIG. 4 is a graph of Malodor Counteractant Formulation Grams Malodor (g) 100% POJ from the table above. Overall the NH₄ OH and TEGODEO® A30 ECO solutions were the best performers, while NaOH and Neutral were a close second and third, respectively. Even the lowest performing ZnO/ZnRicO solution outperformed FEBREZE® FABRIC' by 21% and the NH₄ OH and TEGODEO® A30 ECO each outperformed FEBREZE® FABRIC™ by 46%. Both the TEGODEO® A30 ECO and NH₄ OH were about 17 times more effective at reducing malodor than pure water.

The next malodor utilized was Liquid Ass (referred to as LA), a commercially available “gag” malodor. It was reduced to a 1.0 weight percent solution by adding 1.0 gram LA to 99.0 grams of water. The same test procedure and data analysis was followed with LA to give the results in the table below:

| Malodor | Wt of MC | Odor Detected | Weight (g) |
|---|---|---|---|
| Counteractant | Solution (g) | (g 1.0% LA) | 100% LA |
| Neutral | 10.02 | 9.03 | 0.09 |
| NaOH | 10.02 | 9.03 | 0.09 |
| NH4OH | 10.03 | 9.81 | 0.10 |
| Febreze | 10.02 | 5.50 | 0.06 |
| Tegodeo | 10.01 | 8.25 | 0.08 |
| Water | 10.03 | 3.54 | 0.04 |

FIG. 5 is a graph of Malodor Counteractant Formulation versus Grams Malodor (g) 100% LA. The NH4OH was the best performer in this case, performing slightly better than Neutral or NaOH. TEGODEO® A30 ECO was third in performance with LA malodor while FEBREZE® FABRIC™ had the lowest performance of all. NH4OH outperformed TEGODEO® A30 ECO by 16% and FEBREZE® FABRIC™ by 39%.

Finally, a third test was performed using isovaleric acid (IVA) as the malodor source. A 0.08 wt % solution was made by mixing 0.08 grams IVA with 99.92 grams of water. The same test procedure and data analysis was followed with IVA to give the results presented in the table below.

| Malodor | Wt of MC | Odor Detected | Weight (g) |
|---|---|---|---|
| Counteractant | Solution (g) | (g 0.08% IVA) | 100% IVA |
| Neutral | 10.01 | 3.2 | 0.0026 |
| NaOH | 10.02 | 3.6 | 0.0029 |
| NH4OH | 10.04 | 3.6 | 0.0029 |
| Febreze | 10.01 | 0.42 | 0.00034 |
| Tegodeo | 10.01 | 0.42 | 0.00034 |
| Water | 10.00 | 0.35 | 0.00028 |

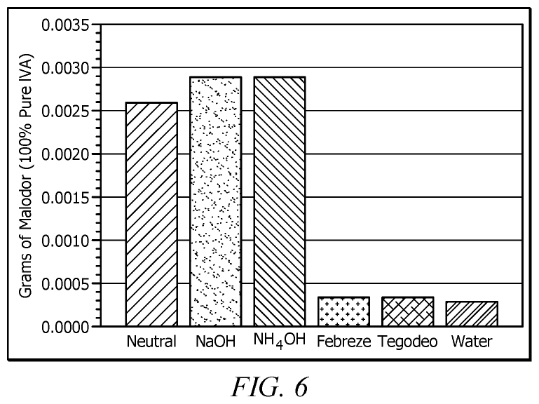

FIG. 6 is a graph of Malodor Counteractant Formulation versus Grams Malodor (g) 100% Pure IVA. Surprisingly, the ZnO/ZnRicO NPs malodor counteractant formulations greatly outperformed both commercially available malodor counteractants FEBREZE® FABRIC™ and TEGODEO® A30 ECO. NaOH and NH 4 OH performed 88% better than both FEBREZE® FABRIC™ and TEGODEO® A30 ECO.

Abbreviations used herein may include:

| | | | |
|---|---|---|---|
| Arginine | L-Arginine | L-Arginine | AK Scientific |
| ZnRicO | Zinc | zinc bis[(9Z,12R)-12- | www.makeyourown.buzz |
| | Ricinoleate | hydroxy-9-octadecenoate] | |
| ZnCl2 | Zinc Chloride | Zinc Chloride | Spectrum Chemicals |
| CA | Citric Acid | 2-hydroxypropane-1,2,3- | Ball |
| | | tricarboxylic acid | |
| PG | Propylene | Propane-1,2-diol | Glycerin Supplier |
| | Glycol | | |

### ADDITIONAL DESCRIPTION

Aspect 1. A malodor counteractant formulation comprising: a malodor counteractant composition comprising metal oxide zinc ricinoleate nanocomposite particles; and a surfactant composition comprising a zwitterionic surfactant, a nonionic alkoxylated linear alcohol surfactant, or both.

Aspect 2. The malodor counteractant formulation of Aspect 1, wherein the metal in the metal oxide is selected from zinc, copper, iron, titanium, or combinations thereof.

Aspect 3. The malodor counteractant formulation of Aspect 1 or 2, wherein a dimension of the metal oxide zinc ricinoleate nanocomposite particles is in a range of from 1 nm to 1 mm.

Aspect 4. The malodor counteractant formulation of Aspect 3, wherein the dimension is in a range of from 1 nm to 100 nm.

Aspect 5A. The malodor counteractant formulation of any one of Aspects 1 to 4, wherein the malodor counteractant composition is present in an amount of from 3 wt % to 15% based on a total weight of the formulation.

Aspect 5B. The malodor counteractant formulation of any one of Aspects 1 to 5A, wherein the nanocomposite particles are present in an amount of from about 0.1 wt % to about 15 wt %; alternatively, from about 0.5 wt % to about 0.6 wt %; alternatively, from about 3 wt % to about 15 wt %; alternatively, 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 wt % based on a total weight of the formulation.

Aspect 6. The malodor counteractant formulation of any one of Aspects 1 to 5B, wherein the surfactant composition is present in an amount of from 5 wt % to 60 wt % based on a total weight of the formulation.

Aspect 7. The malodor counteractant formulation of any one of Aspects 1 to 5B, wherein the surfactant composition is present in an amount of from 5 wt % to 22.5 wt % based on a total weight of the formulation.

Aspect 8. The malodor counteractant formulation of Aspect 7, wherein the malodor counteractant composition is present in an amount of from 6 wt % to 10 wt % based on a total weight of the formulation.

Aspect 9. The malodor counteractant formulation of any one of Aspects 1 to 5B, wherein the surfactant composition is present in an amount of from 5.65 wt % to 11.25 wt % based on a total weight of the formulation.

Aspect 10. The malodor counteractant formulation of Aspect 9, wherein the malodor counteractant composition is present in an amount of from 6 wt % to 7 wt % based on a total weight of the formulation.

Aspect 11. The malodor counteractant formulation of any one of Aspects 1 to 5B, wherein the surfactant composition is present in an amount of from 22.5 wt % to 60 wt % based on a total weight of the formulation.

Aspect 12A. The malodor counteractant formulation of Aspect 11, wherein the malodor counteractant composition is present in an amount of from 10 wt % to 14 wt % based on a total weight of the formulation.

Aspect 12B. The malodor counteractant formulation of Aspect 11 or 12A, which is a concentrate formulation.

Aspect 13. The malodor counteractant formulation of any one of Aspects 1 to 12, wherein the surfactant composition comprises the zwitterionic surfactant, wherein the zwitterionic surfactant comprises a betaine surfactant.

Aspect 14. The malodor counteractant formulation of Aspect 13, wherein the betaine surfactant is cocamidopropyl betaine.

Aspect 15. The malodor counteractant formulation of any one of Aspects 1 to 14, wherein the nonionic alkoxylated linear alcohol surfactant is SURFONIC® JL-80X.

Aspect 16. The malodor counteractant formulation of any one of Aspects 1 to 15, further comprising: a solubility aid, water, a structure directing agent, a pH adjusting agent, or combinations thereof.

Aspect 17. The malodor counteractant formulation of Aspect 16, wherein the pH adjusting agent is citric acid.

Aspect 18. A method for preparing metal oxide zinc ricinoleate nanocomposite particles, the method comprising a first stage and a second stage, and in the first stage: forming metal oxide zinc ricinoleate nanocomposite seed particles in a base solution; and in the second stage: growing the metal oxide zinc ricinoleate nanocomposite seed particles in the base solution to form the metal oxide zinc ricinoleate nanocomposite particles in the base solution.

Aspect 19. The method of Aspect 18, wherein the metal in the metal oxide is selected from zinc, copper, iron, titanium, or combinations thereof.

Aspect 20. The method of Aspect 18 or 19, wherein a dimension of the metal oxide zinc ricinoleate nanocomposite particles is in a range of from 1 nm to 1 mm, alternatively, in a range of from 1 nm to 100 nm.

Aspect 21. A method for preparing a malodor counteractant formulation, the method comprising: combining a base solution containing metal oxide zinc ricinoleate nanocomposite particles with a surfactant composition, wherein the surfactant composition comprises a zwitterionic surfactant, a nonionic alkoxylated linear alcohol surfactant, or both.

Aspect 22. The method of Aspect 21, wherein the base solution is prepared according to any one of Aspects 18 to 20.

Aspect 23. A method for counteracting malodors applying the formulation of any one of Aspects 1 to 17 to a target environment.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A malodor counteractant formulation comprising:
a malodor counteractant composition comprising metal oxide zinc ricinoleate nanocomposite particles; and
a surfactant composition comprising a zwitterionic surfactant, a nonionic alkoxylated linear alcohol surfactant, or both.

2. The malodor counteractant formulation of claim 1, wherein the metal in the metal oxide is selected from zinc, copper, iron, titanium, or combinations thereof.

3. The malodor counteractant formulation of claim 1, wherein a dimension of the metal oxide zinc ricinoleate nanocomposite particles is in a range of from 1 nm to 1 mm.

4. The malodor counteractant formulation of claim 3, wherein the dimension is in a range of from 1 nm to 100 nm.

5. The malodor counteractant formulation of claim 1, wherein the surfactant composition is present in an amount of from 5 wt % to 60 wt % based on a total weight of the formulation.

6. The malodor counteractant formulation of claim 5, wherein the malodor counteractant composition is present in an amount of from 6 wt % to 14% based on a total weight of the formulation.

7. The malodor counteractant formulation of claim 1, wherein the surfactant composition is present in an amount of from 5.65 wt % to 22.5 wt % based on a total weight of the formulation.

8. The malodor counteractant formulation of claim 7, wherein the malodor counteractant composition is present in an amount of from 6 wt % to 10 wt % based on a total weight of the formulation.

9. The malodor counteractant formulation of claim 1, wherein the surfactant composition is present in an amount of from 5.65 wt % to 11.25 wt % based on a total weight of the formulation.

10. The malodor counteractant formulation of claim 9, wherein the malodor counteractant composition is present in an amount of from 6 wt % to 7 wt % based on a total weight of the formulation.

11. The malodor counteractant formulation of claim 1, wherein the surfactant composition is present in an amount of from 22.5 wt % to 60 wt % based on a total weight of the formulation.

12. The malodor counteractant formulation of claim 11, wherein the malodor counteractant composition is present in an amount of from 10 wt % to 14 wt % based on a total weight of the formulation.

13. The malodor counteractant formulation of claim 1, wherein the surfactant composition comprises the zwitterionic surfactant, wherein the zwitterionic surfactant comprises a betaine surfactant.

14. The malodor counteractant formulation of claim 13, wherein the betaine surfactant is cocamidopropyl betaine.

15. The malodor counteractant formulation of claim 14, wherein the nonionic alkoxylated linear alcohol surfactant is SURFONICO JL-80X.

16. The malodor counteractant formulation of claim 1, further comprising:
a solubility aid; and
a structure directing agent.

17. The malodor counteractant formulation of claim 16, further comprising a pH adjusting agent.

18. A method for preparing metal oxide zinc ricinoleate nanocomposite particles, the method comprising a first stage and a second stage, and
in the first stage:
forming metal oxide zinc ricinoleate nanocomposite seed particles in a base solution; and
in the second stage:
growing the metal oxide zinc ricinoleate nanocomposite seed particles in the base solution to form the metal oxide zinc ricinoleate nanocomposite particles in the base solution.

19. A method for preparing a malodor counteractant formulation, the method comprising:
combining a base solution containing metal oxide zinc ricinoleate nanocomposite particles with a surfactant composition, wherein the surfactant composition comprises a zwitterionic surfactant, a nonionic alkoxylated linear alcohol surfactant, or both.

20. A method for counteracting malodors comprising:
applying the formulation of claim 1 to a target environment.
